(19) United States
(12) Patent Application Publication
(10) Pub. No.: US 2025/0038594 A1
(43) Pub. Date: Jan. 30, 2025

(54) ROTOR, ELECTRIC MOTOR, BLOWER, AND AIR CONDITIONER

(71) Applicant: Mitsubishi Electric Corporation, Tokyo (JP)

(72) Inventors: Takanori WATANABE, Tokyo (JP); Kazuchika TSUCHIDA, Tokyo (JP); Takaya SHIMOKAWA, Tokyo (JP); Ryogo TAKAHASHI, Tokyo (JP)

(21) Appl. No.: 18/716,279

(22) PCT Filed: Jan. 26, 2022
(86) PCT No.: PCT/JP2022/002861

§ 371 Date: Jun. 4, 2024

(51) Int. Cl. H02K 1/2733; H02K 1/02; H02K 1/278; H02K 7/14

(52) U.S. Cl. CPC H02K 1/2733; H02K 1/02; H02K 1/278; H02K 7/14; H02K 2213/03

(57) ABSTRACT

A rotor includes a rotation shaft, a first resin magnet supported by the rotation shaft, and a plurality of second resin magnets provided on a first outer peripheral surface, which is a surface facing outward in a radial direction of the first resin magnet, and including a magnetic pole stronger than a magnetic pole of the first resin magnet. When a first length, which is a length of the first resin magnet in the axial direction of the rotation shaft, is L1 and a second length, which is a length of each second resin magnet in the axial direction of the plurality of second resin magnets, is L2, L1>L2.

### CROSS REFERENCE TO RELATED APPLICATION

This application is a U.S. national stage application of PCT/JP2022/002861 filed on Jan. 26, 2022, the contents of which are incorporated herein by reference.

### TECHNICAL FIELD

The present disclosure relates to a rotor, an electric motor, a blower, and an air conditioner.

### BACKGROUND

There are known configurations in which a rotor of an electric motor includes two types of permanent magnets with different magnetic properties. See, for example, Patent Reference 1 to 3.

The rotors described in Patent Reference 1 and 2 include a ferrite resin magnet and a rare earth resin magnet disposed on the outer peripheral surface of the ferrite resin magnet. The shape of the rare earth resin magnets in Patent Reference 1 and 2 when viewed in the axial direction is annular.

The rotor described in Patent Reference 3 includes a ferrite resin magnet and a plurality of rare earth resin magnets arranged on the outer peripheral surface of the ferrite resin magnet. For that reason, the cost of the rotor in Patent Reference 3 is reduced from the cost of the rotors in Patent Reference 1 and 2.

### PATENT REFERENCE

Patent Reference 1: Japanese Unexamined Patent Application Publication No. 2005-151757
Patent Reference 2: Japanese Unexamined Patent Application Publication No. 2011-087393
Patent Reference 3: Japanese Unexamined Patent Application Publication No. 2007-208104

However, in the rotor described in Patent Reference 3, the distribution of the surface magnetic flux density is non-uniform. Specifically, in the rotor of Patent Reference 3, the magnetic force of the ferrite resin magnet is weaker than the magnetic force of the rare earth resin magnet, and thus the distribution of the surface magnetic flux density in the rotor does not form a uniform sinusoidal waveform. For that reason, distortion of effective magnetic flux that interlinks a stator core disadvantageously occurs.

### SUMMARY

It is an object of the present disclosure to prevent occurrence of distortion of effective magnetic flux.

A rotor according to an aspect of the present disclosure includes a rotation shaft; a first resin magnet supported by the rotation shaft; and a plurality of second resin magnets provided on an outer peripheral surface of the first resin magnet and having magnetic force stronger than a magnetic pole of the first resin magnet, wherein the first resin magnet has an annular shape, and L1>L2, where L1 is a first length that is a length of the first resin magnet in an axial direction, and L2 is a second length that is a length of each second resin magnet of the plurality of second resin magnets in the axial direction.

An electric motor according to another aspect of the present disclosure includes the electric motor described above and a stator.

A blower according to another aspect of the present disclosure includes the electric motor described above and an impeller to be driven by the electric motor.

An air conditioner according to another aspect of the present disclosure includes an indoor unit; and an outdoor unit connected to the indoor unit, wherein at least one of the indoor unit or the outdoor unit includes the electric motor described above.

According to the present disclosure, occurrence of distortion of effective magnetic flux can be prevented.

### BRIEF DESCRIPTION OF THE DRAWINGS

FIG. 1 is a plan view showing the configuration of an electric motor according to a first embodiment.

FIG. 2 is a partial cross-sectional view showing the configuration of the electric motor according to the first embodiment.

FIG. 3 is a side surface view showing the configuration of a rotor shown in FIG. 1.

FIG. 4 is an enlarged plan view showing the configuration of the rotor 1 shown in FIG. 1.

FIG. 5 is a plan view of a ferrite resin magnet shown in FIG. 4.

FIG. 6 is a cross-sectional view of the rotor shown in FIG. 4, taken along the line B6-B6.

FIG. 7A is a plan view showing the configuration of a rotor according to a first comparative example. FIG. 7B is a side surface view showing the configuration of the rotor according to the first comparative example.

FIG. 8A is a plan view showing the configuration of a rotor according to a second comparative example. FIG. 8B is a side surface view showing the configuration of the rotor according to the second comparative example.

FIG. 9 is a graph showing the distribution of the surface magnetic flux density of the rotors according to the first embodiment and first comparative example and the distribution of the rotor according to the second comparative example.

FIG. 10 is a graph showing the distribution of the effective flux linkage of the rotor according to the first embodiment, the distribution of the effective flux linkage of the rotor according to the first comparative example, and the distribution of the effective flux linkage of the rotor according to the second comparative example.

FIG. 11 is a partial cross-sectional view showing the configurations of the stator and the rotor according to the first embodiment.

FIG. 12 is a graph showing the increasing rate of flux linkage of the ferrite resin magnet shown in FIG. 11 to overhang ratio.

FIG. 13 is a flowchart showing the manufacturing process of the rotor according to the first embodiment.

FIG. 14 is a plan view showing part of the configuration of a rotor according to a second embodiment.

FIG. 15 is a side surface view showing the configuration of a rotor according to a third embodiment.

FIG. 16 is a cross-sectional view of the rotor shown in FIG. 15, taken along the line B16-B16.

FIG. 17 is a cross-sectional view of the rotor shown in FIG. 15, taken along the line B17-B17.

FIG. 18 is a cross-sectional view of the rotor shown in FIG. 17, taken along the line B18-B18.

FIG. 19 is a plan view showing the configuration of a rotor according to a fourth embodiment.

FIG. 20 is a cross-sectional view of the rotor shown in FIG. 19, taken along the line B20-B20.

FIG. 21 is a plan view showing the configuration of a rotor according to a fifth embodiment.

FIG. 22 is a cross-sectional view of the rotor shown in FIG. 21, taken along the line B22-B22.

FIG. 23 is a cross-sectional view schematically showing the configuration of a rotor according to a modification of the fifth embodiment.

FIG. 24 is a cross-sectional view of the rotor shown in FIG. 23, taken along the line B24-B24.

FIG. 25 is a diagram schematically showing the configuration of the blower according to a sixth embodiment.

FIG. 26 is a diagram schematically showing the configuration of the air conditioner according to a seventh embodiment.

### DETAILED DESCRIPTION

Hereafter, a rotor, an electric motor, a blower, and an air conditioner according to embodiments of the present disclosure will be described with reference to the drawings. The embodiments hereafter are only examples, and various changes are possible within the scope of the present disclosure.

To facilitate understanding of the relationship between the drawings, the xyz orthogonal coordinate system is shown in some of the drawings. The z-axis is the coordinate axis parallel to the axis A of the rotor. The x-axis is the coordinate axis orthogonal to the z-axis. The y-axis is the coordinate axis orthogonal to both of the x-axis and the z-axis.

### First Embodiment

### Configuration of Electric Motor 100

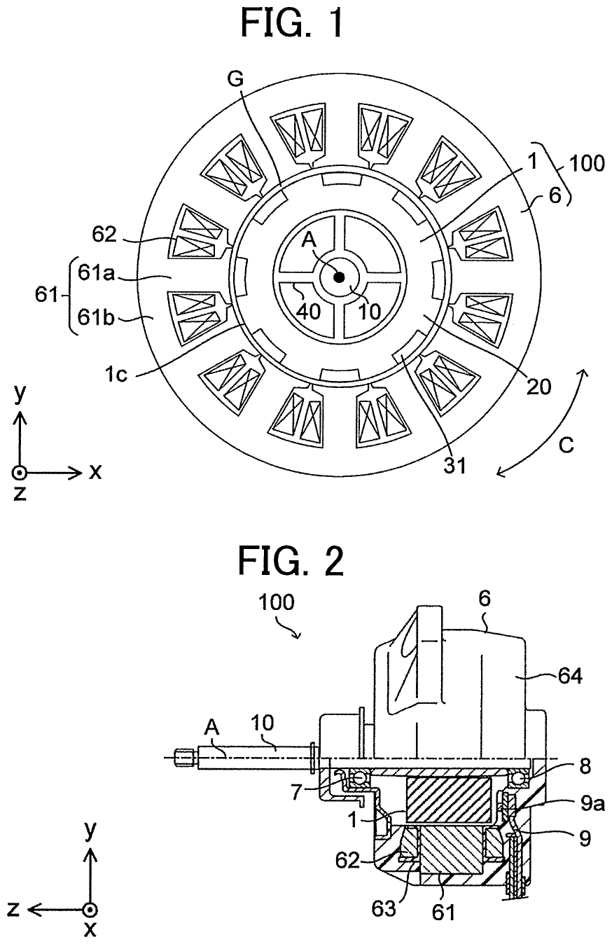

FIG. 1 is a plan view showing the configuration of an electric motor 100 according to the first embodiment. FIG. 2 is a partial cross-sectional view showing the configuration of the electric motor 100 according to the first embodiment. The electric motor 100 is, for example, a permanent magnet synchronous motor. The electric motor 100 includes a rotor 1 and a stator 6.

The rotor 1 is disposed inside the stator 6. In other words, the electric motor 100 is an inner rotor electric motor. An air gap G is formed between the rotor 1 and the stator 6. The air gap G is a gap of 0.5 mm, for example.

The rotor 1 includes a shaft 10 as a rotation axis. The shaft 10 extends in the z-axis direction. In the description hereafter, the z-axis direction is also referred to as the “axial direction”. Also, a direction along the circumference of the circle about the axis A of the shaft 10 is referred to as a “circumferential direction C”, and a direction along the line, which is perpendicular to the z-axis direction, passing through the axis A is referred to as a “radial direction”. The axis A is the rotation center axis of the rotor 1. An xy plane is a plane perpendicular to the axial direction of the rotor 1. It should be noted that other configurations of the rotor 1 are described below.

The stator 6 includes a stator core 61, a coil 62, an insulator 63, and a molded resin 64.

As shown in FIG. 1, the stator core 61 includes a yoke 61a having an annular shape about the axis A and a plurality of teeth 61b extending inward in the radial direction from the yoke 61a. The plurality of teeth 61b are disposed at equiangular gaps in the circumferential direction C. The teeth 61b face the outer peripheral surface 1c of the rotor 1 with the air gap G in between. In the example shown in FIG. 1, the number of teeth 61b is 12. It should be noted that the number of teeth 61b is not limited to 12, but only has to be any number of two or more.

The coil 62 is wound around the stator core 61. The insulator 63 insulates the stator core 61 from the coil 62. The molded resin 64 covers the stator core 61, the coil 62, and the insulator 63. It should be noted that the stator 6 can be achieved without including the molded resin 64.

In the example shown in FIG. 2, the electric motor 100 further includes a circuit board 9 equipped with a magnetic sensor 9a. The magnetic sensor 9a detects the position of the rotor 1 in the circumferential direction C by detecting the magnetic field of the sensor magnet (not shown) provided in the rotor 1. It should be noted that the electric motor 100 can be achieved without including the magnetic sensor 9a.

### Configuration of Rotor 1

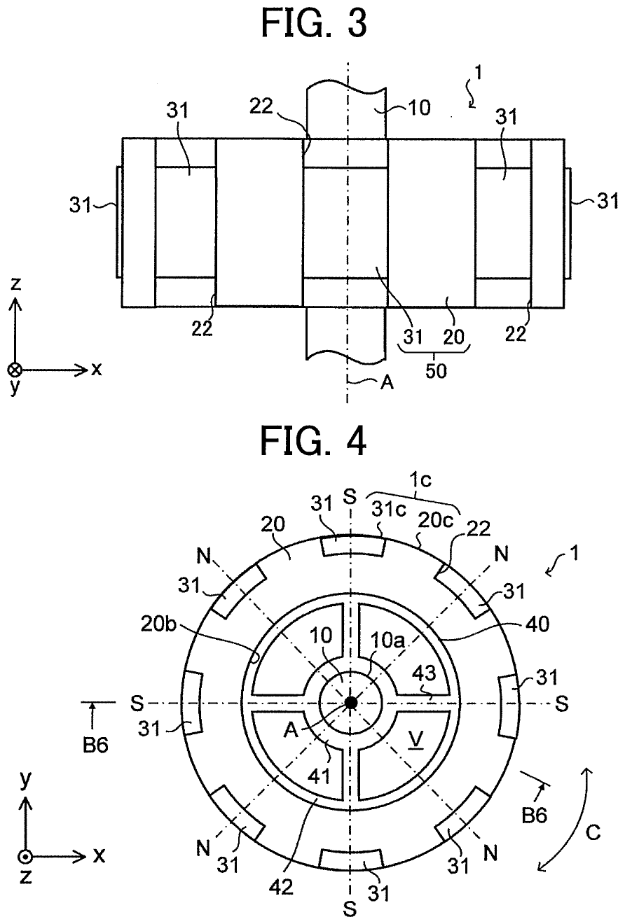

Next, the details of the configuration of the rotor 1 will be described. FIG. 3 is a side surface view showing the configuration of the rotor 1 shown in FIG. 1. FIG. 4 is an enlarged plan view showing the configuration of the rotor 1 shown in FIG. 1. The rotor 1 includes 2n (n is a natural number greater than or equal to 1) magnetic poles, which is a predetermined even number. In the first embodiment, the rotor 1 includes eight magnetic poles.

The rotor 1 includes the shaft 10, a ferrite resin magnet 20 as a first resin magnet, a plurality of rare earth resin magnets 31 as a plurality of second resin magnets, and a resin 40. The number of rare earth resin magnets 31 is the same as the number of magnetic poles of the rotor 1. In other words, the number of rare earth resin magnets 31 is an even number of N. It should be noted that the ferrite resin magnet 20 is also referred to as a “ferrite bonded magnet”, and the rare earth resin magnets 31 are also referred to as “rare earth bonded magnets”.

In the example shown in FIG. 4, the ferrite resin magnet 20 is supported by the shaft 10 with the resin 40 in between. The resin 40 is formed of, for example, unsaturated polyester resin. The resin 40 includes an inner cylindrical portion 41, an outer cylindrical portion 42, and a plurality of ribs 43 (e.g., four ribs). The inner cylindrical portion 41 is cylindrical and is fixed to an outer peripheral surface 10a of the shaft 10. The outer cylindrical portion 42 is cylindrical and is fixed to an inner peripheral surface 20b of the ferrite resin magnet 20. The plurality of ribs 43 connect the inner cylindrical portion 41 and the outer cylindrical portion 42. The plurality of ribs 43 extend radially outward in the radial direction from the outer peripheral surface of the inner cylindrical portion 41. A void V is formed between two ribs 43 adjacent to each other in the circumferential direction C. It should be noted that the ferrite resin magnet 20 may be fixed directly to the shaft 10 without the resin 40. Also, in the description hereafter, the resin 40 is also referred to as a “first resin 40”.

### Configuration of Ferrite Resin Magnet 20

Next, the configuration of the ferrite resin magnet 20 will be described. The ferrite resin magnet 20 includes a ferrite magnet and resin. The resin contained in the ferrite magnet 20 is, for example, at least one of nylon resin, poly phenylene sulfide (PPS) resin, or epoxy resin.

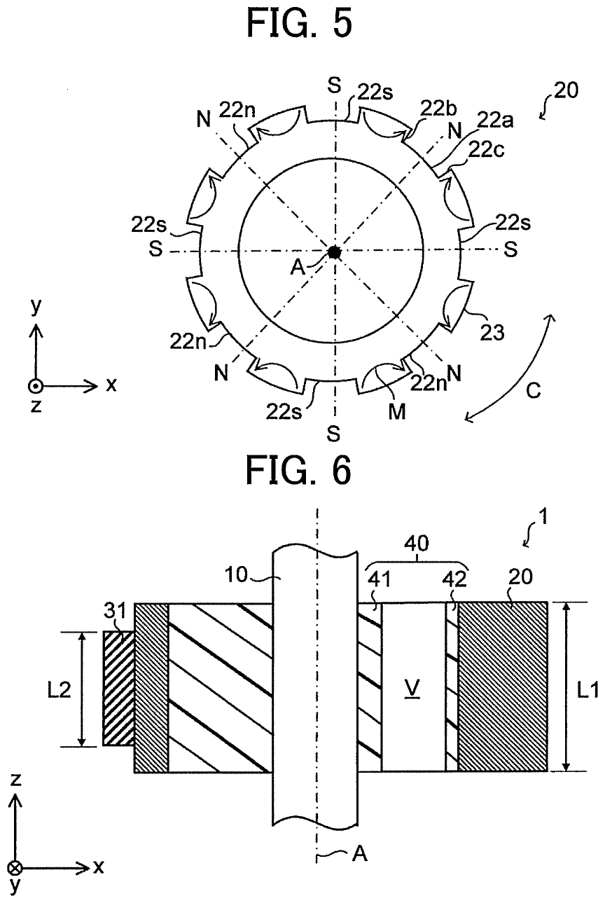

FIG. 5 is a plan view of the ferrite resin magnet 20 shown in FIG. 4. As shown in FIG. 5, the planar shape of the ferrite resin magnet 20 parallel to the xy plane is an annular shape about the axis A. The outer peripheral surface 20c of the ferrite resin magnet 20 as a first peripheral surface forms part of the outer peripheral surface 1c of the rotor 1 (see FIG. 4). It should be noted that the outer peripheral surface 20c is a surface, which faces outward in the radial direction, of the ferrite resin magnet 20.

The ferrite resin magnet 20 includes a plurality of depressions 22 in the outer peripheral surface 20c. The rare earth resin magnets 31 are disposed in the depressions 22, respectively (FIG. 4). The number of depressions 22 is the same as each of the number of rare earth resin magnets 31 and the number of magnetic poles of the rotor 1. In other words, the number of depressions 22 is an even number of N (e.g., eight). The depressions 22 are disposed at predetermined spaces in the circumferential direction C. In the example shown in FIG. 5, the depressions 22 are equally spaced in the circumferential direction C. Each of the depressions 22 is a long depression extending in the z-axis direction.

The depression 22 includes a bottom surface 22a and side surfaces 22b and 22c. The bottom surface 22a is a surface facing outward in the radial direction of the depression 22. The side surfaces 22b and 22c extend outward in the radial direction from the both ends in a width direction of the bottom surface 22a. In the example shown in FIG. 5, the side surfaces 22b and 22c extend outward in the radial direction so that the depression 22 widens. The side surfaces 22b and 22c are boundary portions between the ferrite resin magnet 20 and the rare earth resin magnet 31 (hereafter also referred to as “magnet boundary portions”).

The ferrite resin magnet 20 is magnetized to have a polar anisotropic orientation. Accordingly, magnetic poles of different polarity are formed in the two depressions 22 adjacent to each other in the circumferential direction C. In FIG. 5, the magnetic lines of force M are the magnetic lines of force formed between the adjacent magnetic poles (i.e., N and S magnetic poles) in the circumferential direction C in the ferrite resin magnet 20. The magnetic lines of force M indicate the direction of the oriented magnetic field formed by the adjacent magnetic poles of the ferrite resin magnet 20.

In FIG. 5, the depression 22 in the N-pole is expressed as 22n, and the depression 22 in the S-pole is expressed as 22s. In the first embodiment, the depression 22n in the N-pole and the depression 22s in the S-pole are disposed alternately in the circumferential direction C. The magnetic flux (not shown) that flows in from the outside of the depression 22s in the S-pole in the radial direction proceeds to the depression 22n in the N-pole which is adjacent to the depression 22s in the circumferential direction C. Thus, the rotor 1 (see FIG. 3) does not require a rotor core that constitutes a magnetic path inward from the ferrite resin magnet 20 in the radial direction. Accordingly, the number of parts in the rotor 1 can be reduced and the rotor 1 can be made lighter.

In the ferrite resin magnet 20, the portion between the depression 22n in the N-pole and the depression 22s in the S-pole, which are adjacent to each other in the circumferential direction C, constitutes an inter-pole portion 23 of the rotor 1.

### Configuration of Rare Earth Resin Magnet 31

Next, the configuration of the rare earth resin magnet 31 will be described with reference to FIG. 3 and FIG. 4. The rare earth resin magnet 31 constitutes a pole center portion of the rotor 1.

The rare earth resin magnet 31 includes a rare earth magnet and resin. The rare earth magnet is, for example, a neodymium magnet, which contains neodymium (Nd), iron (Fe), and boron (B), or a samarium iron nitrogen magnet, which contains samarium (Sm), Fe, and nitrogen (N). The resin contained in the rare earth resin magnet 31 is the same as the resin contained in the ferrite resin magnet 20, for example. That is, the resin contained in the rare earth resin magnet 31 is, for example, at least one of nylon resin, PPS resin, or epoxy resin.

The magnetic pole strength (i.e., quantity of magnetism) of the rare earth resin magnet 31 is greater than the magnetic pole strength of the ferrite resin magnet 20. In other words, the magnetic force of the rare earth resin magnet 31 is greater than the magnetic force of the ferrite resin magnet 20. Also, the coefficient of linear expansion of the rare earth resin magnet 31 is different from the coefficient of linear expansion of the ferrite resin magnet 20. Thus, the rare earth resin magnet 31 is formed from a different material than the ferrite resin magnet 20.

The rare earth resin magnets 31 are disposed at spaces in the circumferential direction C. In the example shown in FIG. 4, the rare earth resin magnets 31 are equally spaced in the circumferential direction C. The outer peripheral surface 31c as a second outer peripheral surface of the rare earth resin magnet 31 forms part of the outer peripheral surface 1c of the rotor 1.

Each rare earth resin magnet 31 is magnetized to have a polar anisotropic orientation. The rare earth resin magnets 31 adjacent to each other in the circumferential direction C have magnetic poles of different polarity. The ferrite resin magnet 20 and the plurality of rare earth resin magnets 31 compose a rotor body 50 supported by the shaft 10. Accordingly, a higher output and higher efficiency of the electric motor 100 can be achieved compared to a configuration in which a rotor has only a ferrite resin magnet. Also, in a configuration where a rotor has only a ferrite resin magnet, it is necessary to increase the size of the rotor to achieve the desired output. In contrast, the rotor 1 includes the plurality of rare earth resin magnets 31, and thus it is possible to achieve the downsizing of the rotor 1.

Each of the rare earth resin magnets 31 is joined to the corresponding one of the depressions 22 of the ferrite resin magnet 20. In the first embodiment, the ferrite resin magnet 20 and the rare earth resin magnets 31 are unitedly molded (hereafter also referred to as “two-color molding”), and thus the rare earth resin magnets 31 are joined to the depressions 22 of the ferrite resin magnet 20. In other words, the depressions 22 are filled with the corresponding rare earth resin magnets 31.

In the following description, unitedly molding the ferrite resin magnet 20 and the rare earth resin magnets 31 means that molding the rare earth resin magnets 31 in a state where the ferrite resin magnet 20, which has been previously manufactured, is placed in a mold. Thus, compared to the manufacturing process in which the ferrite resin magnet 20 is molded in a state where the plurality of rare earth resin magnets 31 placed in a mold, the first embodiment eliminates the work of placing the plurality of rare earth resin magnets 31 one by one in a mold. Therefore, the productivity of the rotor body 50 can be improved.

### Prevention of Distortion of Effective Magnetic Flux

FIG. 6 is a cross-sectional view of the rotor 1 shown in FIG. 4, taken along the line B6-B6. In FIG. 6, let L1 be the length of the ferrite resin magnet 20 in the z-axis direction (also referred to as a “first length”), and let L2 be the length of the rare earth resin magnet 31 in the z-axis direction (also referred to as a “second length”). The axial length L1 is longer than the axial length L2. That is, the relationship between the axial length L1 and the axial length L2 is expressed as the following expression (1).

$$L 1 > L 2 \qquad ( 1 )$$

As described above, the ferrite resin magnet 20 forms the inter-pole portion 23 of the rotor 1, and the rare earth resin magnet 31 forms the pole center of the rotor 1. When the axial length L1 and the axial length L2 satisfy the expression (1), the amount of the effective magnetic flux that interlinks the inter-pole portion 23 of the rotor 1 with the stator core 61 (hereafter also referred to as “effective flux linkage”) increases, and thus the occurrence of distortion of the effective magnetic flux can be prevented.

### Contrast with Comparative Examples

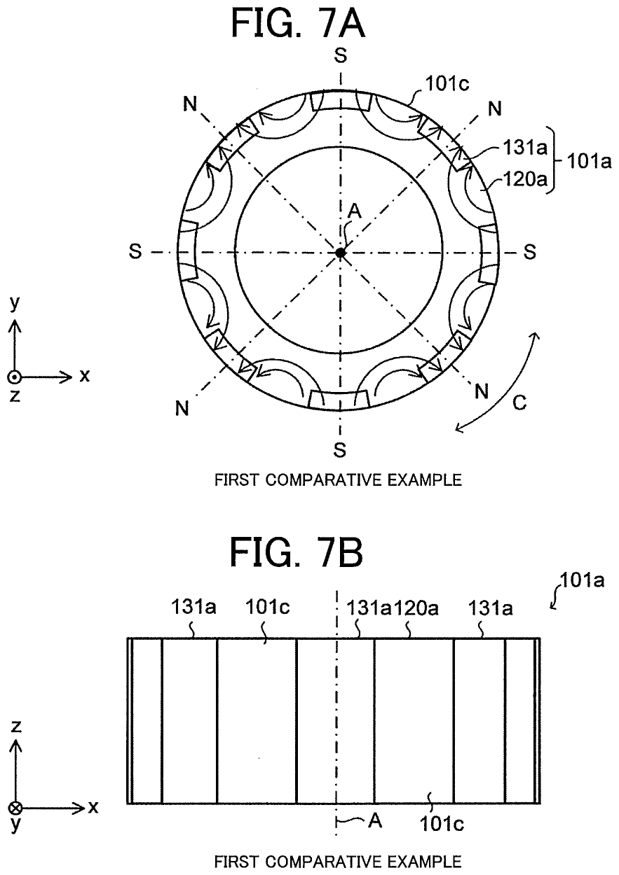

Next, the advantages of having the axial length L1 longer than the axial length L2 will be described with reference to rotors 101a and 101b according to first and second comparative examples. FIG. 7A is a plan view showing the configuration of the rotor 101a according to the first comparative example. FIG. 7B is a side surface view showing the configuration of the rotor 101a according to the first comparative example. The rotor 101a differs from the rotor 1 according to the first embodiment in that the axial length of the ferrite resin magnet 120a in the z-axis direction and the axial length of the rare earth resin magnet 130a in the z-axis direction are the same.

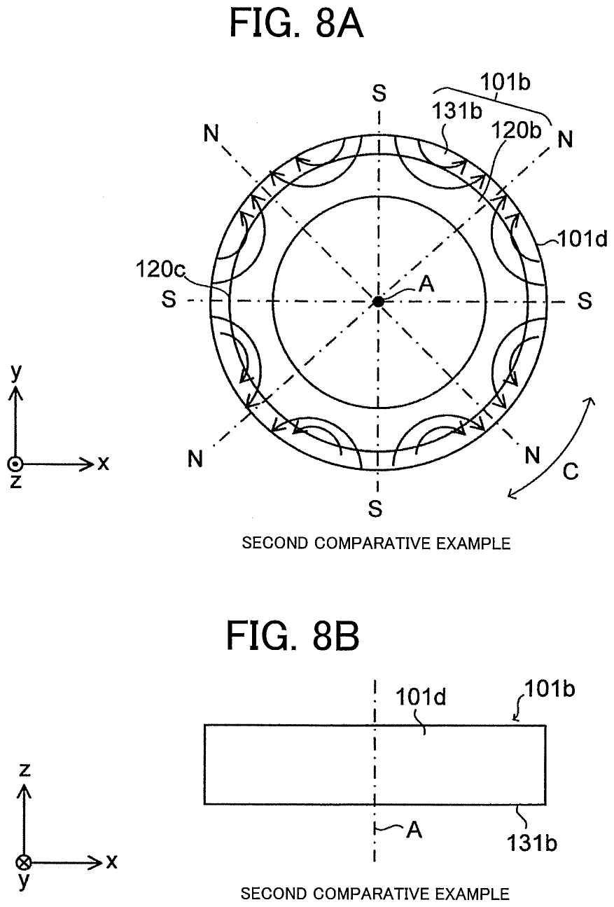

FIG. 8A is a plan view showing the configuration of the rotor 101b according to the second comparative example. FIG. 8B is a side surface view showing the configuration of the rotor 101b according to the second comparative example. In the rotor 101b, a rare earth resin magnet 131b having an annular shape is disposed on an outer peripheral surface 120c of a ferrite resin magnet 120b having an annular shape. In other words, the rotor 101b differs from the rotor 1 according to the first embodiment and the rotor 101a according to the comparative example in that all of the outer peripheral surface 101d of the rotor 101b is formed by the rare earth resin magnet 131b. Also, the rotor 101b differs from the rotor 1 according to the first embodiment in that the axial length of the ferrite resin magnet 120b in the z-axis direction is the same as the axial length of the rare earth resin magnet 131b in the z-axis direction.

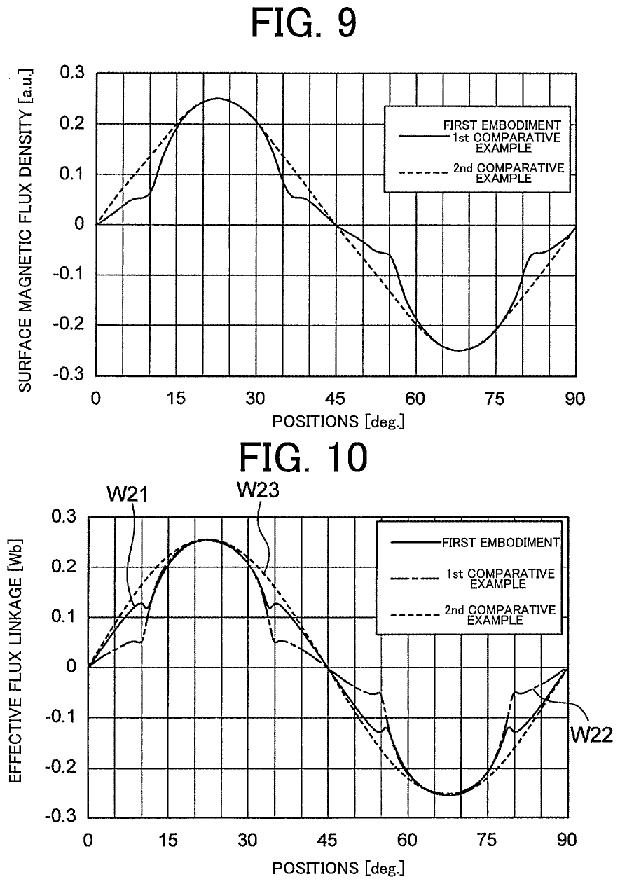

FIG. 9 is a graph showing the distribution of the surface magnetic flux density of the rotors 1 and 101a according to the first embodiment and first comparative example and the distribution of the rotor 101b according to the second comparative example. In FIG. 9, the horizontal axis indicates the positions (unit: degrees) in the circumferential direction C on the outer peripheral surfaces 1c, 101c, and 101d of the rotors 1, 101a, and 101b, respectively, and the vertical axis indicates the surface magnetic flux density (unit: a.u.). Also, in FIG. 9, the graph shown by the solid line shows the waveform of the distribution of the surface magnetic flux density of the rotors 1 and 101a according to the first embodiment and first comparative example, and the graph shown by the dashed line shows the waveform of the distribution of the surface magnetic flux density of the rotor 101b according to the second comparative example.

The waveform of the distribution of the surface magnetic flux density of the rotor 101b according to the second comparative example is a sinusoidal waveform. In other words, in the rotor 101b according to the second comparative example, the variation of the surface magnetic flux density is uniform in the circumferential direction C. On the other hand, the waveform of the distribution of the surface magnetic flux density of the first embodiment and first comparative example shown by the solid line on the graph is not as smooth as the waveform of the distribution of the surface magnetic flux density of the second comparative example shown by the broken line on the graph. In other words, the variation of the surface magnetic flux density is not uniform in the rotors 1 and 101a. Specifically, distortion occurs in the portion, which corresponds to the inter-pole portions of the rotors 1 and 101a, of the waveform shown by the solid line on the graph.

FIG. 10 is a graph showing the distribution of the effective flux linkage of the rotor 1 according to the first embodiment, the distribution of the effective flux linkage of the rotor 101a according to the first comparative example, and the distribution of the effective flux linkage of the rotor 101b according to the second comparative example. In FIG. 10, the horizontal axis indicates the positions (unit: degrees) on the outer peripheral surfaces 1c, 101c, and 101d in the circumferential direction C of the rotors 1, 101a, and 101b, respectively, and the vertical axis indicates the effective flux linkage (unit: Wb). Also, in FIG. 10, the solid line shows the waveform W21 of the distribution of the effective flux linkage of the rotor 1 according to the first embodiment. In addition, in FIG. 10, the dash-dot line shows the waveform W22 of the distribution of the effective flux linkage of the rotor 101a according to the first comparative example, and the dashed line shows the waveform W23 of the distribution of the effective flux linkage of the rotor 101b according to the second comparative example.

The waveform W23 is a sinusoidal waveform. In other words, in the rotor 101b according to the second comparative example, the surface magnetic flux density changes uniformly in the circumferential direction C. On the other hand, the waveform W22 is not as smooth as the waveform W23. In other words, in the rotor 101b, the variation of the surface magnetic flux density is not uniform. Specifically, distortion occurs in the waveform W22 at the inter-pole portion 23 of the rotor 1. When the distribution of the surface magnetic flux density is represented by the waveform W22, the effective flux linkage that interlinks the stator core 61 (see FIG. 3) is disadvantageously distorted.

On the other hand, the waveform W21 has a shape similar to a sine wave compared to the waveform W22. This is because, in the first embodiment, the axial length L1 of the ferrite resin magnet 20 is longer than the axial length L2 of the rare earth resin magnet 31. Accordingly, the amount of effective flux linkage flowing from the ferrite resin magnet 20, which forms the inter-pole portion 23 (see FIG. 5) of the rotor 1, to the stator core 61 (FIG. 3) increases. Thus, the generation of distortion of the effective flux linkage that interlinks the stator core 61 can be suppressed in the inter-pole portion 23 of the rotor 1. Therefore, the distortion of the induced voltage and the generation of cogging torque, which cause vibration and noise in the electric motor 100, are suppressed.

Next, when the magnetic force (unit: T) of the ferrite resin magnet 20 is Br1 and the magnetic force (unit: T) of the rare earth resin magnet 31 is Br2, the product of the axial length L1 and the magnetic force Br1 is greater than the product of the axial length L2 and the magnetic force Br2 in the first embodiment. In other words, the relationship between the axial length L1, the magnetic force Br1, the axial length L2, and the magnetic force Br2 is expressed as the following expression (2).

$$L 1 \cdot Br 1 > L 2 \cdot Br 2 \qquad ( 2 )$$

By transforming the expression (2), it becomes the following expression (3).

$$L 1 > L 2 \cdot Br 2 / Br 1 \qquad ( 3 )$$

Thus, the axial length L1 of the ferrite resin magnet 20 is proportional to the ratio Br2/Br1 of the magnetic force Br2 of the rare earth resin magnet 31 to the magnetic force Br1 of the ferrite resin magnet 20. Hence, by lengthening the axial length L1 of the ferrite resin magnet 20 according to the ratio Br2/Br1, the amount of effective magnetic flux that interlinks the inter-pole portion 23 of the rotor 1 with the stator core 61 can be increased. Therefore, the generation of distortion of the effective magnetic flux in the inter-pole portion 23 of the rotor 1 can be further suppressed.

### Cost of Rotor 1

Next, the cost of the rotor 1 according to the first embodiment will be described with reference to the rotor 101b according to the second comparative example. As described above, in the rotor 101b according to the second comparative example, all of the outer peripheral surface 101d of the rotor 101b is formed by the rare earth resin magnet 131b.

In contrast, as described above in FIG. 4, the outer peripheral surface 1c of the rotor 1 is formed by the outer peripheral surface 20c of the ferrite resin magnet 20 and the outer peripheral surfaces 31c of the plurality of rare earth resin magnets 31. Accordingly, the amount of rare earth resin magnets 31 used in the rotor 1 can be reduced compared to the rotor 101b. Specifically, the amount of rare earth resin magnets 31 used in the rotor 1 can be reduced by about 20% compared to the rotor 101b.

Also, the rare earth resin magnets 31 are more expensive than the ferrite resin magnet 20. For example, the unit cost of material of the rare earth resin magnet 31 is more than 10 times the unit cost of material of the ferrite resin magnet 20. For that reason, forming the outer peripheral surface 1c of the rotor 1 by the outer peripheral surface 20c of the ferrite resin magnet 20 and the outer peripheral surfaces 31c of the plurality of rare earth resin magnets 31 can reduce the amount of the rare earth resin magnets 31, and thus the cost of the rotor 1 can be reduced.

### Relationship Between Axial Length of Ferrite Resin Magnet 20 and Axial Length of Stator Core 61

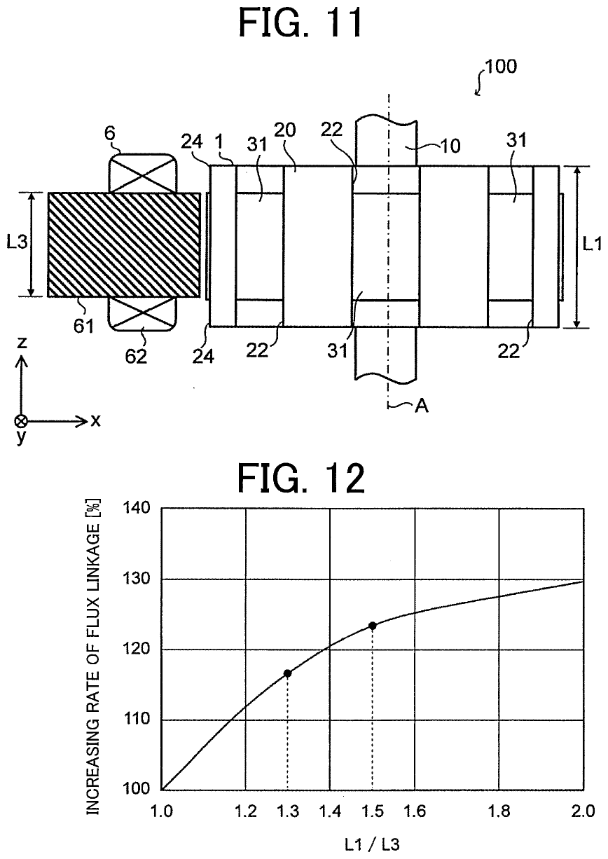

Next, the relationship between the axial length of the ferrite magnet 20 and the axial length of the stator core 61 will be described with reference to FIG. 11 and FIG. 12. FIG. 11 is a partial cross-sectional view showing the configurations of the stator 6 and the rotor according to the first embodiment. In FIG. 11, when the axial length of the stator core 61 is L3, the axial length L1 of the ferrite resin magnet 20 is longer than the axial length L3 of the stator core 61. Accordingly, the effective magnetic flux that interlinks the ferrite magnet 20 with the stator core 61 can be increased. In other words, the ferrite resin magnet 20 can increase the amount of effective magnetic flux that interlinks portions 24 of the ferrite resin magnet 20 not facing the stator core 61 in the radial direction (hereafter also referred to as “overhang portions”) with the stator core 61.

On the other hand, if the axial length L1 of the ferrite resin magnet 20 is too large relative to the axial length L3 of the stator core 61, the amount of the ferrite resin magnet 20 increases. Also, as a result of the inventor's diligent research, it is found that if the axial length L1 of the ferrite resin magnet 20 is too long with respect to the axial length L3 of the stator core 61, that is, if the length of the overhang portion 24 is too long, the increasing rate of the quantity of the flux linkage that interlinks the stator core 61 decreases.

FIG. 12 is a graph showing the relationship between the ratio L1/L3 and the increasing rate of the flux linkage. In FIG. 12, the horizontal axis indicates the ratio L1/L3, and the vertical axis indicates the increasing rate (unit: %) of the flux linkage that interlinks the ferrite resin magnet 20 with the stator core 61. As shown in FIG. 12, when the ratio L1/L3 is 1.5 or more, the increasing rate of the flux linkage decreases compared to a case where the ratio L1/L3 is less than 1.5. Therefore, it is preferable that the ratio L1/L3 be less than 1.5. In other words, it is preferable that the relationship between the axial length L1 of the ferrite resin magnet 20 and the axial length L3 of the stator core 61 should satisfy the following expression (4). Accordingly, the amount of the ferrite resin magnet 20 is suppressed, and the amount of the flux linkage can be increased.

$$L 1 < 1.5 < L 3 \qquad ( 4 )$$

Also, in the example shown in FIG. 12, when the ratio L1/L3 is equal to or greater than 1.3, the increasing rate of the flux linkage is lower than a case where the ratio L1/L3 is less than 1.3. Therefore, it is more preferable that the ratio L1/L3 be less than 1.3. In other words, the relationship between the axial length L1 of the ferrite resin magnet 20 and the axial length L3 of the stator core 61 should satisfy the following expression (5). Accordingly, the amount of the ferrite resin magnet 20 is further suppressed, and the amount of the flux linkage can be further increased.

$$L 1 \leq 1.3 \cdot L 3 \qquad ( 5 )$$

### Manufacturing Method of Rotor 1

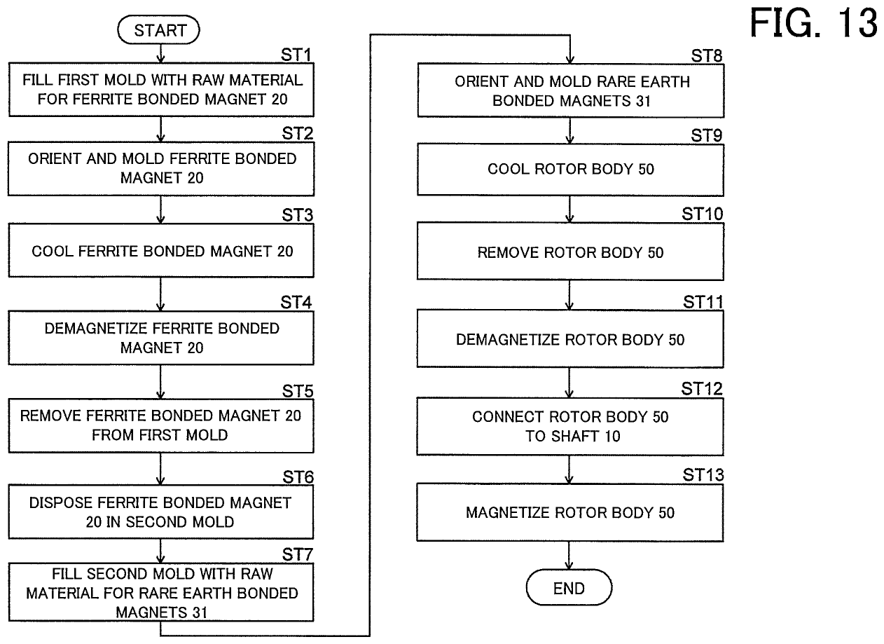

Next, the manufacturing method of the rotor 1 will be described with reference to FIG. 13. FIG. 13 is a flowchart showing the manufacturing process of the rotor 1. In the manufacturing process of the rotor 1, a first mold for molding the ferrite resin magnet 20, a second mold for molding the rare earth resin magnets 31, magnets for orientation, and a magnetizer are used.

In a step ST1, the first mold for molding the ferrite resin magnet 20 is filled with the raw material for the ferrite resin magnet 20. The ferrite resin magnet 20 is molded, for example, by injection molding. It should be noted that the ferrite resin magnet 20 may be molded by other molding methods such as pressure molding, not limited to injection molding.

In a step ST2, the ferrite resin magnet 20 is oriented and molded into a predetermined shape. In the step ST2, in a state where a magnetic field having polar anisotropy is generated inside the first mold using a magnet for orienting, the raw material of the ferrite resin magnet 20 is oriented and the ferrite resin magnet 20 is molded, for example. Accordingly, the ferrite resin magnet 20 having polar anisotropy is molded.

In a step ST3, the molded ferrite resin magnet 20 is cooled.

In a step ST4, the ferrite resin magnet 20 is removed from the first mold.

In a step ST5, the removed ferrite resin magnet 20 is demagnetized.

In a step ST6, the ferrite resin magnet 20 is disposed inside the second mold for molding the rare earth resin magnets 31 with injection molding.

In a step ST7, depressions 22 of the ferrite resin magnet 20 disposed in the second mold is filled with the raw material for the rare earth resin magnets 31. The rare earth resin magnets 31 are molded by injection molding, for example. It should be noted that the rare earth resin magnets 31 may be molded by other molding methods such as pressure molding as well as injection molding.

In a step ST8, the raw material of the rare earth resin magnets 31 is oriented, and each rare earth resin magnet 31 is molded into a predetermined shape. In the step ST8, in a state where a magnetic field having polar anisotropy is generated inside the second mold using a magnet for orienting, the raw material of the rare earth resin magnets 31 is oriented and the rare earth resin magnets 31 are molded, for example. Accordingly, the rotor body 50 in which the ferrite resin magnet 20 and a plurality of rare earth resin magnets 31 are unitedly molded is formed.

In a step ST9, the rotor body 50 formed in the step ST8 is cooled.

In a step ST10, the cooled rotor body 50 is removed from the second mold.

In a step ST11, the rotor body 50 removed in the step ST10 is demagnetized.

In a step ST12, the rotor body 50 is connected to the shaft 10. In the first embodiment, the rotor body 50 is connected to the shaft 10 by uniting the rotor body 50 and the shaft 10 with the resin 40 in between.

In a step ST13, the rotor body 50 is magnetized using, for example, a magnetizer.

### Advantages of First Embodiment

According to the first embodiment described above, the rotor 1 includes the ferrite resin magnet 20 and the rare earth resin magnets 31 disposed in the depressions 22 provided in the outer peripheral surface 20c of the ferrite resin magnet 20. Accordingly, the outer peripheral surface 1c of the rotor 1 is formed by the outer peripheral surface 20c of the ferrite resin magnet 20 and the outer peripheral surfaces 31c of the plurality of rare earth resin magnets 31. Thus, the amount of the rare earth resin magnets 31 is reduced compared to the rotor 101b according to the second comparative example in which all of the outer peripheral surface 101d of the rotor 101b is formed by the rare earth resin magnet 131b. Therefore, the cost of the rotor 1 can be reduced compared to the cost of the rotor 101b according to the second comparative example.

Also, according to the first embodiment, the axial length L1 of the ferrite resin magnet 20 is longer than the axial length L2 of the rare earth resin magnet 31. Accordingly, the amount of the flux linkage that interlinks the ferrite resin magnet 20, which forms the inter-pole portion 23 of the rotor 1, with the stator core 61 is increased. Therefore, since the waveform W1 of the distribution of the surface magnetic flux density of the rotor 1 approaches the sinusoidal waveform W3, the generation of distortion of the effective magnetic flux in the inter-pole portion 23 can be suppressed.

Also, according to the first embodiment, the axial length L1 of the ferrite resin magnet 20 satisfies the expression (3) described above. Thus, the axial length L1 of the ferrite resin magnet 20 can be lengthened according to the ratio Br2/Br1 of the magnetic force Br2 of the rare earth resin magnet 31 to the magnetic force Br1 of the ferrite resin magnet 20. Accordingly, the amount of the flux linkage that interlinks the inter-pole portion 23 of the rotor 1 with the stator core 61 can be further increased. Therefore, the generation of distortion of the effective magnetic flux in the inter-pole portion 23 can be further suppressed.

Also, according to the first embodiment, the axial length L1 of the ferrite resin magnet 20 is less than 1.5 times the axial length L3 of the stator core 61. If the axial length L1 of the ferrite resin magnet 20 is longer than the axial length L3 of the stator core 61, the magnetic flux in the overhang portion, which does not face the stator core 61 in the radial direction, of the ferrite resin magnet 20 interlinks the stator core 61. For that reason, the amount of the flux linkage can be increased. On the other hand, as a result of the inventor's diligent research, it is found that when the axial length L1 exceeds 1.5 times the axial length L3, the increasing rate of the flux linkage that interlinks the ferrite resin magnet 20 with the stator core 61 decreases. Therefore, when the axial length L1 is less than 1.5 times the axial length L3, the generation of distortion of the effective flux can be suppressed by reducing the amount of the ferrite resin magnet 20 and increasing the amount of the flux linkage.

Also, according to the first embodiment, the axial length L1 of the ferrite resin magnet 20 is less than 1.3 times the axial length L3 of the stator core 61. Accordingly, the amount of the ferrite resin magnet 20 used in the rotor 1 is further reduced, and the amount of the flux linkage can be further increased.

Also, according to the first embodiment, the electric motor 100 includes the rotor 1 and the stator 6. As described above, the rotor 1 can suppress the generation of distortion of the effective magnetic flux. Therefore, since the electric motor 100 includes the rotor 1, the reduction in the power of the electric motor 100 can be suppressed. Also, vibration and noise in the electric motor 100 can be reduced because induced voltage distortion and cogging torque are less likely to occur.

### Second Embodiment

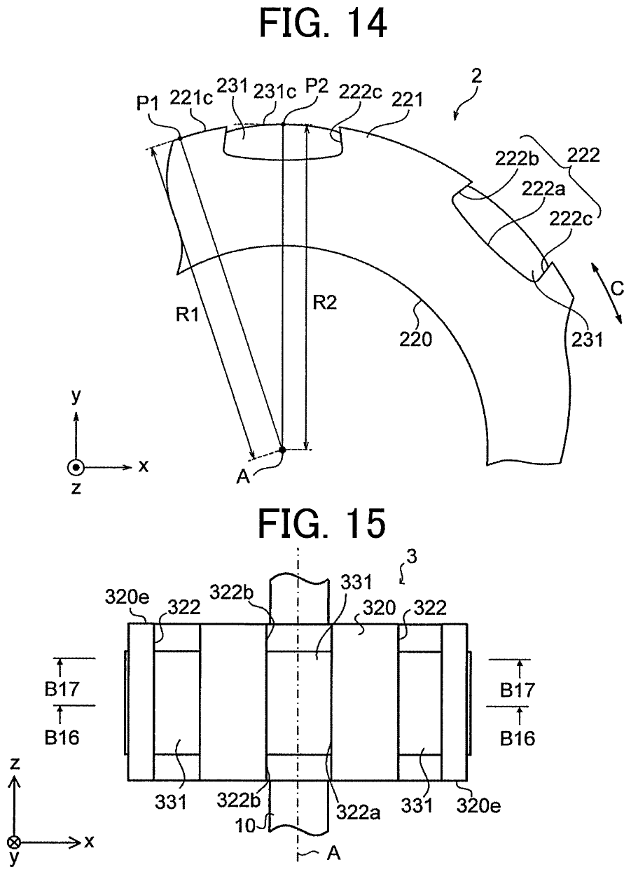

FIG. 14 is a plan view showing part of the configuration of a rotor 2 according to a second embodiment. In FIG. 14, each component identical or corresponding to a component shown in FIG. 4 is assigned the same reference sign as that in FIG. 4. The rotor 2 according to the second embodiment is different in the shapes of a ferrite resin magnet 220 and a rare earth resin magnet 231 from the rotor 1 according to the first embodiment. Other than this, the rotor 2 according to the second embodiment is the same as the rotor 1 according to the first embodiment. For that reason, the following description refers to FIG. 1 and FIG. 3.

As shown in FIG. 14, the rotor 2 includes the shaft 10 (see FIG. 3), a ferrite resin magnet 220, and rare earth resin magnets 231.

The ferrite resin magnet 220 includes a magnet body 221 having a cylindrical shape and a plurality of depressions 222. The magnet body 221 is a portion of the ferrite resin magnet 220 that is supported by the shaft 10. The plurality of depressions 222 are formed on the outer peripheral surface 221c of the magnet body 221. The outer peripheral surface 221c is a surface facing outward in the radial direction of the ferrite resin magnet 220.

In FIG. 14, the distance R1 is a first distance between the axis A and the point P1 on the outer peripheral surface 221c of the magnet body 221, and the distance R2 is a second distance between the axis A and the point P2 on the outer peripheral surface 231c of the rare earth resin magnet 231. The distance R1 is the maximum distance between the outer peripheral surface 221c of the ferrite resin magnet 220 and the axis A. The distance R2 is the maximum distance between the outer peripheral surface 231c of the rare earth resin magnet 231 and the axis A. In the second embodiment, the distance R1 is longer than the distance R2. In other words, the relationship between the distance R1 and the distance R2 is expressed as the following expression (6).

$$R 1 > R 2 \qquad ( 6 )$$

When the distance R1 and the distance R2 satisfy the expression (6), the air gap G (see FIG. 1) between the outer peripheral surface 221c of the ferrite resin magnet 220 and the stator core 61 (see FIG. 1) can be narrowed. Accordingly, the amount of effective magnetic flux that interlinks the stator core 61 increases. Thus, the distortion of the effective magnetic flux in the inter-pole portion of the rotor 2 can be reduced.

Also, the depression 222 of the ferrite resin magnet 220 includes a bottom surface 222a, a first side surface 222b, and a second side surface 222c. The first side surface 222b and the second side surface 222c extend outward in the radial direction from both ends in the width direction of the bottom surface 222a. In the example shown in FIG. 14, the first side surface 222b and the second side 222c extend outward in the radial direction from both ends in the width direction of the bottom surface 222a so that the width of the depression 222 becomes narrower. Accordingly, the rare earth resin magnet 231 disposed in the depression 222 can be prevented from falling out due to centrifugal force acting on the rotor 2 or interfacial peeling caused by expansion or contraction due to temperature change.

### Advantages of Second Embodiment

According to the second embodiment described above, the distance R1 between the point P1 on the outer peripheral surface 221c of the ferrite resin magnet 220 and the axis A of the shaft 10 is longer than the distance R2 between the point P2 on the outer peripheral surface 231c of the rare earth resin magnet 231 and the axis A. Accordingly, the air gap G between the ferrite resin magnet 220 and the stator 6 becomes narrower, and thus the amount of the effective magnetic flux that interlinks the stator core 61 increases. Therefore, the distortion of the effective magnetic flux in the inter-pole portion of the rotor 2 can be reduced.

Also, according to the second embodiment, the first side surface 222b and the second side 222c of the depression extend outward in the radial direction from both ends in the width direction of the bottom surface 222a so that the width of the depression 222 becomes narrower. Accordingly, the rare earth resin magnet 231 can be prevented from falling out due to centrifugal force acting on the rotor 2 or interfacial peeling caused by expansion or contraction due to temperature change.

### Third Embodiment

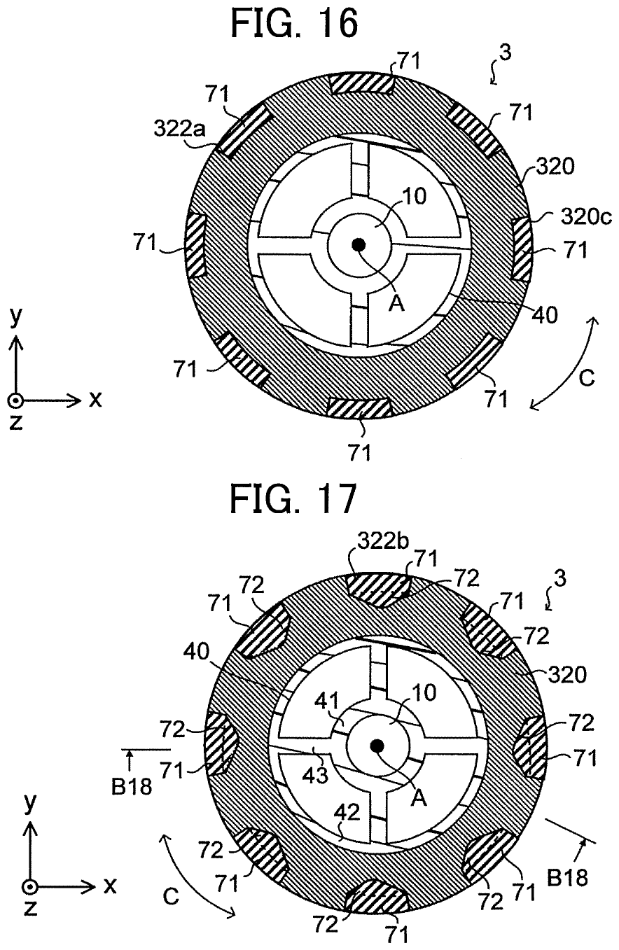

FIG. 15 is a side surface view showing a rotor 3 according to a third embodiment. FIG. 16 is a cross-sectional view of the rotor 3 shown in FIG. 15, taken along the line B16-B16. FIG. 17 is a cross-sectional view of the rotor 3 shown in FIG. 15, taken along the line B17-B17. In FIGS. 15 to 17, components identical or corresponding to components shown in FIGS. 3 and 4 are assigned the same reference sign as those shown in FIGS. 3 and 4. The rotor 3 according to the third embodiment is different in the shape of the ferrite resin magnet 320 and the shape of the rare earth resin magnet 331 from the rotor 1 according to the first embodiment. Other than this, the rotor 3 according to the third embodiment is the same as the rotor 1 according to the first embodiment.

As shown in FIG. 15 to FIG. 17, the rotor 3 includes the shaft 10, a ferrite resin magnet 320, and a plurality of rare earth resin magnets 331.

The ferrite resin magnet 320 includes a plurality of depressions 322 provided on an outer peripheral surface 320c. The rare earth resin magnets 331 are disposed in the depressions 322, respectively. Each depression 322 of the plurality of depressions 322 includes a first portion 322a in which the rare earth resin magnet 331 is disposed and a second portions 322b located on end surface 320e sides in the z-axis direction from the first portion 322a.

As shown in FIG. 16 and FIG. 17, the rare earth resin magnet 331 includes a pillar 71, a projecting portion 72, and a second projecting portion 73.

The pillar 71 extends in the z-axis direction. The pillar 71 is disposed in the depression 322 of the ferrite resin magnet 320. Specifically, the pillar 71 is disposed in the first portion 322a of the depression 322. In the example shown in FIG. 16, the shape of the pillar 71 when viewed in the z-axis direction is, for example, a fan shape. In the xy-plane, each of the inner and outer peripheral surfaces of the pillar 71 has a concentric circle. In other words, the thickness of the pillar 71 in the xy-plane is constant in the circumferential direction C.

FIG. 18 is a cross-sectional view of the rotor 3 shown in FIG. 17, taken along the line B18-B18. As shown in FIGS. 17 and 18, the first projecting portion 72 extends inward in the radial direction from an end 71a on a +z-axis side of the pillar 71. The second projecting portion 73 extends inward in the radial direction from an end 71b on a-z-axis side of the pillar 71. In the example shown in FIG. 17, the width in the circumferential direction C of each of the first projecting portion 72 and the second projecting portion 73 is narrower toward a radially inward direction.

Thus, in the third embodiment, the rare earth resin magnet 331 includes the projecting portion 72 extending inward in the radial direction from the end 71a on the +z-axis side of the pillar 71 and the second projecting portion 73 extending inward in the radial direction from the end 71b on the −z-axis side of the pillar 71. For that reason, in FIG. 18, the distance R3 is longer than the distance R4, where R3 is the distance (third distance) between the center portion in the z-axis direction of the outer peripheral surface 320c of the ferrite resin magnet 320 and the axis A and R4 is the distance (fourth distance) between the end in the z-axis direction of the outer peripheral surface 320c and the axis A. In other words, the relationship between the distance R3 and the distance R4 is expressed as the following expression (7).

$$R 3 > R 4 \qquad ( 7 )$$

The distance R3 is longer than the distance R4, in other words, the depth of the second portion 322b of the depression 322 is deeper than the depth of the first portion 322a of the depression 322 in the ferrite resin magnet 320.

In the rotor 1 according to the first embodiment described above, when the ferrite resin magnet 20 and the rare earth resin magnets 31 are molded by two-color molding, the surfaces, which face inward in the radial direction, of the rare earth resin magnets 31 that contacts the ferrite resin magnet 20 (hereafter referred to as “interfaces”) may fall from the depressions 22 of the ferrite resin magnet 20 because of expansion or contraction due to temperature change or centrifugal force acting on the rotor 1.

On the other hand, in the third embodiment, the distance R3 between the center portion in the z-axis direction of the outer peripheral surface 320c of the ferrite resin magnet 320 and the axis A is longer than the distance R4 between the end in the z-axis direction of the outer peripheral surface 320c and the axis A. Accordingly, the first projecting portions 72 and the second projecting portions 73 shown in FIG. 17 and FIG. 18 can be formed in the rare earth resin magnets 331. In other words, the connection area between the rare earth resin magnets 331 and the ferrite resin magnet 320 is increased at the ends in the z-axis of the rare earth resin magnets 331. Thus, the interfaces of the rare earth resin magnets 331 are difficult to peel off because of expansion or contraction due to temperature change or centrifugal force acting on the rotor 3. Therefore, the rare earth resin magnets 331 are less likely to fall out of the depressions 322 of the ferrite resin magnet 320.

In the example shown in FIG. 17, the shape of each of the first projecting portion 72 and the second projecting portion 73 when viewed in the z-axis direction is, for example, a substantially triangular shape. It should be noted that the shape of each of the first projecting portion 72 and the second projecting portion 73 is not limited to a substantially triangular shape, but may be other shapes. Also, the rare earth resin magnet 331 may include only either the first projecting portion 72 or the second projecting portion 73.

### Advantages of Third Embodiment

According to the third embodiment described above, the distance R3 between the center portion in the z-axis direction of the outer peripheral surface 320c of the ferrite resin magnet 320 and the axis A is longer than the distance R4 between the end in the z-axis direction of the outer peripheral surface 320c and the axis A. Accordingly, the first projecting portions 72 and the second projecting portions 73 shown in FIG. 17 and FIG. 18 can be formed in the rare earth resin magnets 331. Thus, since the connection area between the rare earth resin magnets 331 and the ferrite resin magnet 320 is increased, the rare earth resin magnets 331 is prevented from falling out of the depressions 322 of the ferrite resin magnet 320 due to expansion or contraction caused by temperature change or centrifugal force acting on the rotor 3. Therefore, the rotor 3 can be provided with high reliability against temperature change and centrifugal force.

### Fourth Embodiment

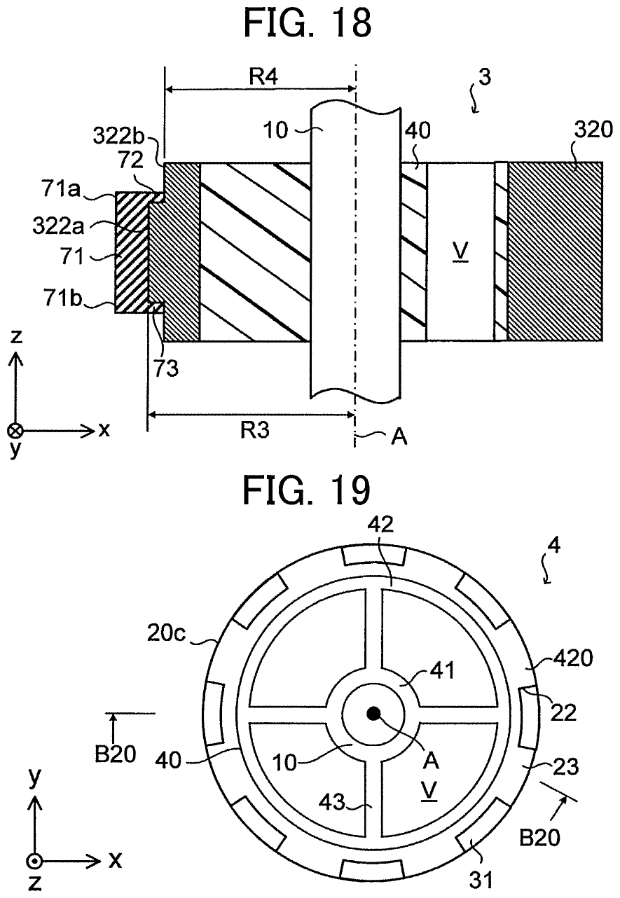

FIG. 19 is a plan view showing the configuration of a rotor 4 according to a fourth embodiment. FIG. 20 is a cross-sectional view of the rotor 4 shown in FIG. 19, taken along the line B20-B20. In FIG. 19 and FIG. 20, components identical or corresponding to components shown in FIG. 3 and FIG. 4 are assigned the same reference signs as those shown in FIG. 3 and FIG. 4. The rotor 4 according to the fourth embodiment is different in the shape of a ferrite resin magnet 420 from the rotor 1 according to the first embodiment. Other than this, the rotor 4 according to the fourth embodiment is the same as the rotor 1 according to the first embodiment. For that reason, the following description refers to FIG. 5.

As shown in FIG. 19 and FIG. 20, the rotor 4 includes the shaft 10, the ferrite resin magnet 420, the plurality of rare earth resin magnets 31, and a resin 406.

In FIG. 20, R5 is the distance (fifth distance) between a center portion 420g in the z-axis direction of the inner peripheral surface 420b of the ferrite resin magnet 420 and the axis A, and R6 is the distance (sixth distance) between an end 420h in the z-axis direction of the inner peripheral surface 420b and the axis A. In the fourth embodiment, the distance R5 is longer than the distance R6. In other words, the distance R5 and the distance R6 are expressed as the following expression (8).

$$R 5 > R 6 \qquad ( 8 )$$

The width in the radial direction of the ferrite resin magnet 120a in the comparative examples described above in FIG. 7A and FIG. 7B requires the thickness necessary to form magnetic paths of polar anisotropic orientation and to support the rare earth resin magnet 31. When the axial length of the ferrite resin magnet 420 is longer than the axial length of the rare earth resin magnet 31, the portion (i.e., end portion in the z-axis direction) of the ferrite resin magnet 420 that is not in contact with the rare earth resin magnet 31 does not need to support the rare earth resin magnet 31. For that reason, the portion of the end portion in the z-axis direction of the ferrite resin magnet 420 that forms the inter-pole portion 23 (see FIG. 5) of the rotor 4 needs only to have a minimum width w to form a magnetic path. Accordingly, the amount of the ferrite resin magnet 420 can be reduced. It should be noted that let be R0 the distance from the axis A to the outer peripheral surface 20c of the ferrite resin magnet 420 in FIG. 20, the width w is the value obtained by subtracting the distance R5 from the distance R0.

### Advantages of Fourth Embodiment

According to the fourth embodiment described above, the distance R5 between the center portion 420g in the z-axis direction of the inner peripheral surface 420b of the ferrite resin magnet 420 and the axis A is shorter than the distance R6 between the end 420h in the z-axis direction of the inner peripheral surface 420b and the axis A. When the axial length L1 of the ferrite resin magnet 420 is longer than the axial length L2 of the rare earth resin magnet 31, the portion (i.e., end portion in the z-axis direction) of the ferrite resin magnet 420 that is not in contact with the rare earth resin magnet 31 does not need to support the rare earth resin magnet 31 and thus needs only to have the thickness w to form a magnetic path in the inter-pole portion 23 (see FIG. 5). Accordingly, the amount of the ferrite resin magnet 420 can be reduced.

### Fifth Embodiment

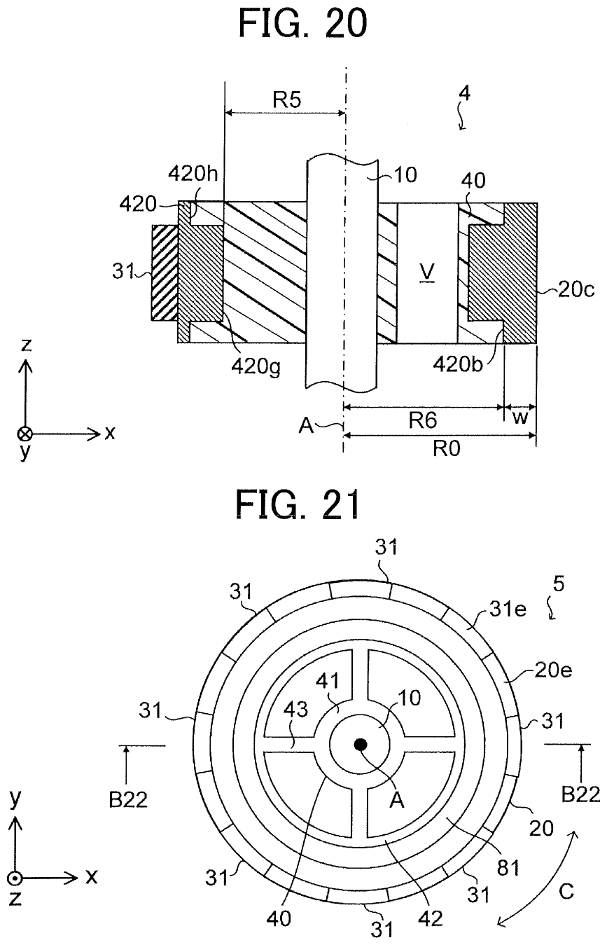

FIG. 21 is a plan view showing the configuration of a rotor 5 according to a fifth embodiment. FIG. 22 is a cross-sectional view of the rotor 5 shown in FIG. 21, taken along the line B22-B22. In FIGS. 21 and 22, components identical or corresponding to components shown in FIGS. 4 and 6 are assigned the same reference signs as those shown in FIGS. 4 and 6. The rotor 5 according to the fifth embodiment is different from the rotors 1 to 4 according to the first to fourth embodiments in that the rotor 5 further includes second resins 81 and 82. Other than this, the rotor 5 according to the fifth embodiment is the same as the rotors 1 to 4 according to the first to fourth embodiments.

As shown in FIG. 21 and FIG. 22, the rotor 5 includes the shaft 10, the ferrite resin magnet 20, the plurality of rare earth resin magnets 31, the first resin 40, and second resins 81 and 82. Each of the second resins 81 and 82 is an annular-shaped member about the axis A. The second resins 81 and 82 are formed of resin material such as, for example, unsaturated polyester resin.

The second resins 81 and 82 are fixed to the ferrite resin magnet 20 and the rare earth resin magnet 31. The second resins 81 and 82 cover ends in the z-axis direction, respectively, of the ferrite resin magnet 20 and the rare earth resin magnet 31. Specifically, the second resin 81 is fixed to the end surface 20e facing the +z-axis direction of the ferrite resin magnet 20 and to the end surface 31e facing the +z-axis direction of the rare earth resin magnet 31. The second resin 82 is fixed to the end surface 20f facing the −z-axis direction of the ferrite resin magnet 20 and to the end surface 31f facing the −z-axis direction of the rare earth resin magnet 31.

Thus, the second resins 81 and 82 are connected to the ends in the z-axis direction, respectively, of the ferrite resin magnet 20 and the rare earth resin magnet 31. Accordingly, the rare earth resin magnet 31 is connected to the ferrite resin magnet 20 via the second resins 81 and 82. Therefore, the rare earth resin magnet 31 can be further prevented from falling out due to centrifugal force acting during rotation. In addition, the rare earth resin magnet 31 can be further prevented from peeling off due to temperature change. It is noted that the rotor 5 needs only to include at least one of the second resins 81 or 82.

### Advantages of Fifth Embodiment

According to the fifth embodiment described above, the rotor 5 further includes the second resins 81 and 82 connected to the ends in the z-axis direction, respectively, of the ferrite resin magnet 20 and the rare earth resin magnet 31. Accordingly, the rare earth resin magnet 31 is connected to the ferrite resin magnet 20 via the second resins 81 and 82. Therefore, the rare earth resin magnet 31 can be further prevented from falling out due to centrifugal force acting during rotation. In addition, the rare earth resin magnet 31 can be further prevented from peeling off due to temperature change. Therefore, the rotor 5 can be provided with high reliability.

### Modification of Fifth Embodiment

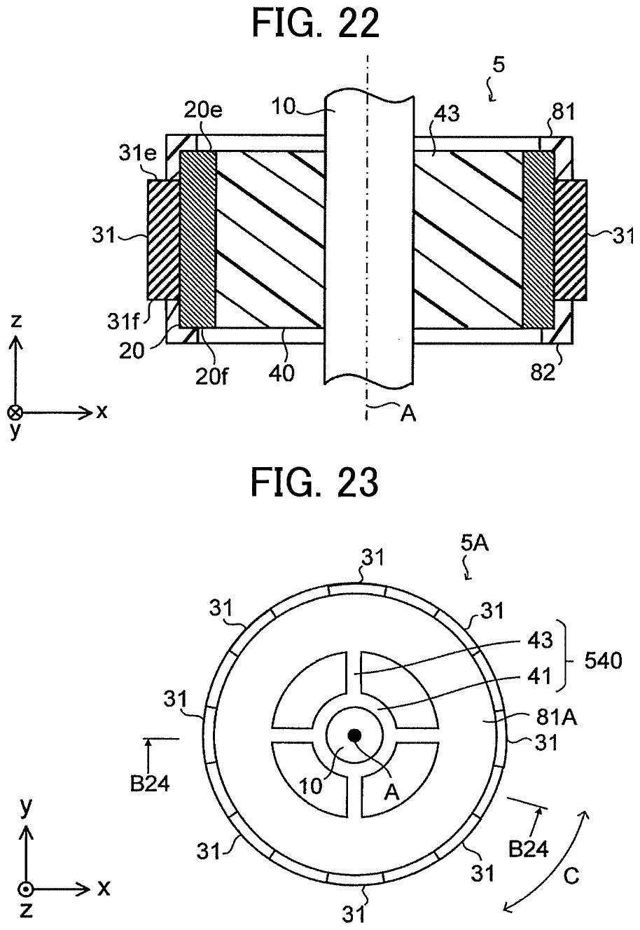

FIG. 23 is a plan view showing the configuration of a rotor 5A according to a modification of the fifth embodiment. FIG. 24 is a cross-sectional view of the rotor 5A shown in FIG. 23, taken along the line B24-B24. The rotor 5A according to the modification of the fifth embodiment differs from the rotor 5 according to the fifth embodiment in that second resins 81A and 82A are integrated with a first resin 540. Other than this, the rotor 5A according to the modification of the fifth embodiment is the same as the rotor 5 according to the fifth embodiment.

As shown in FIG. 23 and FIG. 24, the rotor 5A includes the shaft 10, the ferrite resin magnet 20, the plurality of rare earth resin magnets 31, the first resin 540, and the second resins 81A and 82A. The resin 540 includes an inner cylindrical portion 41 and a plurality of ribs 43 connecting the inner cylindrical portion 41 and the second resins 81A and 82A. The second resins 81A and 82A are connected to ends in the z-axis direction, respectively, of the ferrite resin magnet 20 and the rare earth resin magnet 31.

The second resins 81A and 82A are integrally formed with the resin 540. In other words, the second resins 81A and 82A are connected to the resin 540. For that reason, in the modification of the fifth embodiment, the shaft 10, the ferrite resin magnet 20, and the rare earth resin magnet 31 are connected via the first resin 540 and the second resins 81A and 82A. Accordingly, the strength of the second resins 81A and 82A is enhanced, and thus the rare earth resin magnet 31 can be further prevented from falling out. Also, when the shaft 10 and the ferrite resin magnet 20 are unitedly molded with the resin 540 in between, the second resins 81A and 82A can also be molded at the same time. Therefore, the manufacturing process of the rotor 5A can be simplified.

### Advantages of Modification of Fifth Modification

with the rotor 5A according to the modification of the fifth embodiment described above, the second resins 81A and 82A are formed integrally with the first resin 540. Accordingly, the strength of the second resins 81A and 82A is enhanced, and thus the rare earth resin magnet 31 can be further prevented from falling out. Thus, the rotor 5A can be provided with high reliability. In addition, when the shaft 10 and the ferrite resin magnet 20 are unitedly molded with the resin 540 in between, the second resins 81A and 82A can also be molded at the same time. Therefore, the manufacturing process of the rotor 5A can be simplified.

### Sixth Embodiment

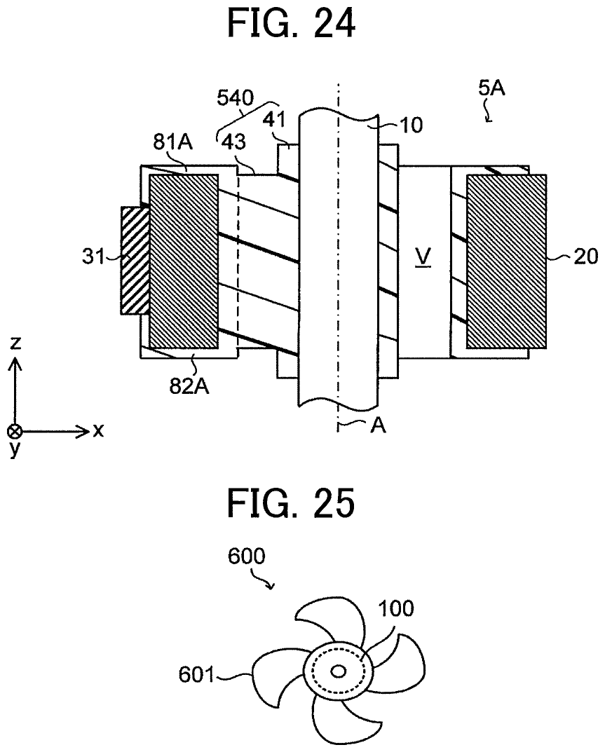

Next, the configuration of a blower 600 according to a sixth embodiment will be described. FIG. 25 is a diagram schematically showing the configuration of the blower 600 according to the sixth embodiment.

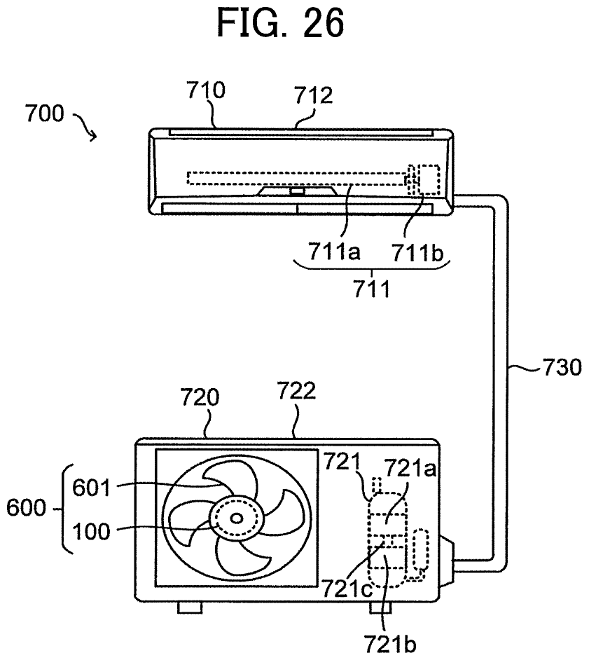

As shown in FIG. 25, the blower 600 includes the electric motor 100 and a fan 601 as an impeller driven by the electric motor 100. The fan 601 is fixed to the shaft 10 of the electric motor 100 (see, for example, FIG. 1). When the shaft 10 of the electric motor 100 rotates, the fan 601 rotates to generate airflow. The blower 600 is used as an outdoor blower of an outdoor unit 720 of an air conditioner 700 shown in FIG. 26 referenced later, for example. In this case, the fan 601 is, for example, a propeller fan.

### Advantages of Sixth Embodiment

According to the sixth embodiment described above, the blower 600 includes the electric motor 100 according to the first embodiment. As described above, since the reduction in the power of the electric motor 100 is suppressed, the reduction in the power of the blower 600 can also be suppressed. In addition, since the vibration and noise in the electric motor 100 are reduced, vibration and noise in the blower 600 can be reduced.

### Seventh Embodiment

Next, the configuration of the air conditioner 700 including the electric motor 100 according to the first embodiment will be described. FIG. 26 is a diagram schematically showing the configuration of the air conditioner 700 according to a seventh embodiment.

As shown in FIG. 26, the air conditioner 700 includes an indoor unit 710, an outdoor unit 720, and refrigerant piping 730. The indoor unit 710 and the outdoor unit 720 are connected by the refrigerant piping 730 to form a refrigerant circuitry in which a refrigerant circulates. The air conditioner 700 is capable of performing a cooling operation of sending cold air from the indoor unit 710, and a heating operation of sending hot air from the indoor unit 710, for example.

The indoor unit 710 includes an indoor blower 711 and a housing 712 that houses the indoor blower 711. The indoor blower 711 includes an electric motor 711a and a fan 711b driven by the electric motor 711a. The fan 711b is attached to the shaft of the electric motor 711a. When the shaft of the electric motor 711a rotates, the fan 711b rotates to generate airflow. The fan 711b is, for example, a cross-flow fan.

The outdoor unit 720 includes a blower 600 as an outdoor blower, a compressor 721, and a housing 722 that houses the blower 600 and the compressor 721. The compressor 721 includes a compression mechanism part 721a to compress a refrigerant and an electric motor 721b to drive the compression mechanism part 721a. The compression mechanism part 721a and the electric motor 721b are connected to each other by the shaft 721c. It should be noted that the electric motor 100 according to the first embodiment may be used for the electric motor 721b of the compressor 721.

For example, during the cooling operation of the air conditioner 700, the heat released when the refrigerant compressed by the compressor 721 condenses in a condenser (not shown) is released outside a room by the airflow of the blower 600. The outdoor unit 720 further includes a four-way valve (not shown) that switches the flow direction of the refrigerant. The four-way valve of the outdoor unit 720 allows high temperature and pressure refrigerant gas delivered from the compressor 721 to flow to the heat exchanger of the outdoor unit 720 during the cooling operation and to the heat exchanger of the indoor unit 710 during the heating operation. It should be noted that the blower 600 according to the sixth embodiment is not limited to the outdoor blower of the outdoor unit 720, but may be used as the indoor blower 711 described above. Also, the electric motor 100 according to the first embodiment is not limited to the air conditioner 700, but may be included in other electrical equipment.

### Advantages of Seventh Embodiment

According to the seventh embodiment described above, the outdoor unit 720 of the air conditioner 700 includes the electric motor 100 according to the first embodiment. As described above, since the reduction in the power of the electric motor 100 is suppressed, the reduction in the power of the air conditioner 700 can also be suppressed. In addition, since the vibration and noise in the electric motor 100 are reduced, the quietness of the air conditioner 700 can be achieved.

1. A rotor comprising:
a rotation shaft;
a first resin magnet supported by the rotation shaft; and
a plurality of second resin magnets provided on a first an outer peripheral surface of the first resin magnet and having magnetic force stronger than a magnetic pole of the first resin magnet,
wherein the first resin magnet has an annular shape, and
L1>L2,
where L1 is a first length that is a length of the first resin magnet in an axial direction, and L2 is a second length that is a length of each second resin magnet of the plurality of second resin magnets in the axial direction.

2. The rotor according to claim 1, wherein
L1·Br1>L2·Br2,
where Br1 is magnetic force of the first resin magnet, and Br2 is magnetic force of the second resin magnet.

3. The rotor according to claim 1, wherein
a first distance that is a maximum distance between the first outer peripheral surface of the first resin magnet and a rotation center axis of the rotor is longer than a second distance that is a maximum distance between an outer peripheral surface of the second resin magnet and the rotation center axis.

4. The rotor according to claim 1, wherein
a third distance that is a distance between a rotation center axis of the rotor and a center portion of the outer peripheral surface of the first resin magnet in the axial direction is longer than a fourth distance that is a distance between the rotation center axis and an end of the outer peripheral surface of the first resin magnet in the axial direction.

5. The rotor according to claim 1, wherein
the first resin magnet includes a plurality of depressions provided on the outer peripheral surface of the first resin magnet, the depressions being equally spaced in a circumferential direction of the first resin magnet, and
the second resin magnets are disposed in the depressions, respectively.

6. The rotor according to claim 5, wherein
each depression of the plurality of depressions includes a first portion in which the second resin magnet is disposed and a second portion located on an end surface side in the axial direction of the first resin magnet from the first portion, and
a depth of the second portion is deeper than a depth of the first portion.

7. The rotor according to claim 1, wherein
the second resin magnet includes a pillar extending in the axial direction and a projecting portion extending inward in a radial direction from an end portion in the axial direction of the pillar, and
the first resin magnet is connected to the projecting portion.

8. The rotor according to claim 1, wherein a fifth distance that is a distance between the rotation center axis of the rotor and a center portion of an inner peripheral surface of the first resin magnet in the axial direction is shorter than a sixth distance that is a distance between the rotation center axis of the rotor and an end of the inner peripheral surface of the first resin magnet in the axial direction.

9. The rotor according to claim 1, further comprising a first resin part connecting the rotation shaft and the first resin magnet.

10. The rotor according to claim 9, further comprising a second resin part connected to each end in the axial direction of the first and second resin magnets.

11. The rotor according to claim 10, wherein the second resin part is integrally formed with the first resin part.

12. The rotor according to claim 1, wherein the first resin magnet is a ferrite resin magnet, and the second resin magnets are rare earth resin magnets.

13. The rotor according to claim 1, wherein
the rotor is a rotor having an even number of magnetic poles, and
each of the first and second resin magnets has a polar anisotropy.

14. An electric motor comprising:
the rotor according to claim 1; and
a stator.

15. The electric motor according to claim 14, wherein
the stator includes a stator core, and
L1<L3·1.5,
where L3 is a third length that is a length of the stator core in the axial direction.

16. The electric motor according to claim 14, wherein
the stator includes a stator core, and
L1<L3·1.3,
where L3 is a third length that is a length of the stator core in the axial direction.

17. A blower comprising:
the electric motor according to claim 14; and
an impeller to be driven by the electric motor.

18. An air conditioner comprising:
an indoor unit; and
an outdoor unit connected to the indoor unit,
wherein at least one of the indoor unit or the outdoor unit includes the electric motor according to claim 14.

19. The rotor according to claim 2, wherein
a first distance that is a maximum distance between the outer peripheral surface of the first resin magnet and a rotation center axis of the rotor is longer than a second distance that is a maximum distance between an outer peripheral surface of the second resin magnet and the rotation center axis.

20. The rotor according to claim 2, wherein
a third distance that is a distance between a rotation center axis of the rotor and a center portion of the outer peripheral surface of the first resin magnet in the axial direction is longer than a fourth distance that is a distance between the rotation center axis and an end of the outer peripheral surface of the first resin magnet in the axial direction.
